(19) United States
(12) Patent Application Publication
(10) Pub. No.: US 2024/0304891 A1
(43) Pub. Date: Sep. 12, 2024

(54) STRUCTURAL BATTERY PACK WITH ADHESIVE AND GAP FILLERS

(71) Applicant: Apple Inc., Cupertino, CA (US)

(72) Inventors: Edward T Hillstrom, Vancouver (CA); Alexander Bartlett, San Jose, CA (US); Nivay Anandarajah, San Leandro, CA (US); Dylan C Erb, San Jose, CA (US); Zhongying Shi, San Jose, CA (US)

(21) Appl. No.: 18/435,903

(22) Filed: Feb. 7, 2024

Related U.S. Application Data
(60) Provisional application No. 63/450,581, filed on Mar. 7, 2023.

(51) Int. Cl. H01M 10/653; H01M 10/655; H01M 50/204

(52) U.S. Cl. CPC H01M 10/653; H01M 10/655; H01M 50/204

(57) ABSTRACT

A battery pack includes an enclosure forming an enclosure interior, a stack of battery cells disposed within the enclosure interior, and an adhesive extending between a wall of the enclosure and the stack. The battery pack also includes a first gap filler extending between the wall and the stack, where the first gap filler is disposed adjacent to a first edge of the stack and includes a first thermal conductivity constant greater than a second thermal conductivity constant of the adhesive. The battery pack also includes a second gap filler extending between the wall and the stack, where the second gap filler is disposed adjacent to a second edge of the stack and includes a third thermal conductivity constant greater than the second thermal conductivity constant.

### CROSS-REFERENCE TO RELATED APPLICATIONS

This application claims priority to U.S. Application No. 63/450,581, filed Mar. 7, 2023, entitled “STRUCTURAL BATTERY PACK WITH ADHESIVE AND GAP FILLERS,” which is incorporated by reference herein in its entirety for all purposes.

### BACKGROUND

The present disclosure relates generally to a battery pack, and more specifically to adhesives and gap fillers arranged between an enclosure of the battery pack and battery cells of the battery pack.

A battery pack may include a number of battery cells, such as rechargeable or secondary battery cells, disposed in an enclosure of the battery pack and configured to generate a charge having a voltage and current for powering a load. For example, the battery cells may be coupled in series such that individual voltages of the battery cells are combined to generate a charge having a total voltage, or in parallel such that individual currents of the battery cells are combined to generate a charge having a total current. In some embodiments, series and parallel couplings are employed between various battery cells of the battery pack to generate a total voltage and total current compatible with the load receiving the charge.

Traditional battery packs may employ various componentry configured to transfer heat away from the battery cells. Unfortunately, such componentry in traditional battery packs may be expensive, inefficient, and/or susceptible to failure.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a battery pack includes an enclosure forming an enclosure interior, a stack of battery cells disposed within the enclosure interior, and an adhesive extending between a wall of the enclosure and the stack. The battery pack also includes a first gap filler extending between the wall and the stack, where the first gap filler is disposed adjacent to a first edge of the stack and includes a first thermal conductivity constant greater than a second thermal conductivity constant of the adhesive. The battery pack also includes a second gap filler extending between the wall and the stack, where the second gap filler is disposed adjacent to a second edge of the stack and includes a third thermal conductivity constant greater than the second thermal conductivity constant.

In another embodiment of the present disclosure, a battery pack includes an enclosure forming an enclosure interior, a stack of battery cells disposed within the enclosure interior, a heat exchanger formed in, or attached to, a wall of the enclosure, and an adhesive extending between the wall and the stack. The battery pack also includes a gap filler extending between the wall and the stack, where the gap filler is disposed adjacent to an edge of the stack and includes a first thermal conductivity constant greater than a second thermal conductivity constant of the adhesive.

In yet another embodiment of the present disclosure, a battery pack includes an enclosure forming an enclosure interior configured to receive a plurality of battery cells, a heat exchanger formed in, or attached to, a wall of the enclosure, a thermal adhesive extending within a plane adjacent to the wall, and a gap filler extending within the plane adjacent to the wall. The gap filler is disposed adjacent to an edge of the thermal adhesive and includes a first thermal conductivity constant greater than a second thermal conductivity constant of the thermal adhesive.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic diagram of a battery pack having an enclosure, a stack of battery cells disposed in the enclosure, a first coating and adhesive assembly, and a gap filler corresponding to a second coating and adhesive assembly, according to embodiments of the present disclosure;

FIG. 2 is an exploded perspective view of the battery pack of FIG. 1, according to embodiments of the present disclosure;

FIG. 3 is a perspective view of a portion of the battery pack of FIG. 1, according to embodiments of the present disclosure;

FIG. 4 is a schematic side view of a portion of the battery pack of FIG. 1, including one of the battery cells of the stack, the gap filler, an additional gap filler, a structural adhesive corresponding to the first coating and adhesive assembly, and a thermal adhesive corresponding to the second coating and adhesive assembly, according to embodiments of the present disclosure;

FIG. 5 is a schematic side view of a portion of the battery pack of FIG. 1, including one of the battery cells of the stack, the gap filler, an additional gap filler, a structural adhesive corresponding to the first coating and adhesive assembly, and an additional structural adhesive corresponding to the second coating and adhesive assembly, according to embodiments of the present disclosure; and

FIG. 6 is a schematic side view of a portion of the battery pack of FIG. 1, including one of the battery cells of the stack, the gap filler, an additional gap filler, a thermal adhesive corresponding to the first coating and adhesive assembly, and an additional thermal adhesive corresponding to the second coating and adhesive assembly, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is generally directed to a battery pack. More specifically, the present disclosure is directed to a battery pack having various adhesives and gap fillers arranged between battery cells of the battery pack and an enclosure of the battery pack. As described in detail below, the adhesives and gap fillers are configured to, among other things, transfer heat from the battery cells to the enclosure.

In accordance with the present disclosure, a battery pack may include a number of battery cells arranged in one or more stacks within an enclosure interior defined by an enclosure. The battery cells may be electrically coupled (e.g., via bus bars) to generate one or more charges, each having a voltage and current compatible with one or more loads powered by the battery pack. In certain embodiments, one or more assemblies may be employed to structurally couple cans of the battery cells with the enclosure, electrically isolate the cans from the enclosure, and transfer heat from the battery cells to the enclosure. For example, a first assembly (e.g., first coating and adhesive assembly) may extend between a stack of battery cells and a first side (e.g., lid) of the enclosure, and a second assembly (e.g., second coating and adhesive assembly) may extend between the stack of battery cells and a second side (e.g., heat exchanger side) of the enclosure, where the second side of the enclosure opposes the first side of the enclosure. Each of the first and second assemblies may include an adhesive (e.g., structural adhesive or thermal adhesive) configured to transfer heat away from the battery cells and toward the enclosure. Further, the structural and/or thermal adhesives may include various properties (e.g., elongation, peel strength, shear strength, flexibility, etc.) suitable for supporting various mechanical loads on the battery pack.

As an example, the second assembly extending between the stack of battery cells and second side (e.g., heat exchanger side) of the enclosure may include an adhesive having a thermal conductivity constant between approximately 0.2 and 1.0, 0.4 and 0.9, or 0.6 and 0.8. In general, the adhesive may be configured to extend along sides of the battery cells of the stack, where the sides of the battery cells are aligned to form a side (e.g., a bottom side) of the stack. In this way, a heat exchange relationship may be established between the adhesive and each battery cell of the stack. The adhesive may be configured to transfer heat from the stack of battery cells toward the heat exchanger formed in, or attached to, the second side of the enclosure. In some embodiments, the heat exchanger is configured to receive a heat exchange fluid that carries the heat away from the second side of the enclosure.

In accordance with the present disclosure, gap fillers may be disposed on opposing sides of the adhesive of the second assembly. For example, a first gap filler may extend along a first side of the adhesive and a second gap filler may extend along a second side of the adhesive opposing the first side. In this way, the first gap filler, the adhesive, and the second gap filler may be disposed in a plane extending along (e.g., underneath) the side (e.g., the bottom side) of the stack of battery cells. Further, the above-described arrangement may enable the first gap filler to extend along a first edge of the stack of battery cells and the second gap filler to extend along a second edge of the stack of battery cells. In some embodiments, each of the first and second gap fillers may be configured to act as a fluid damn that contains the adhesive of the second assembly therebetween. For example, the first gap filler and the second gap filler may be positioned in the plane described above prior to depositing the adhesive between the first gap filler and the second gap filler.

The battery cells may generate a relative large amount of heat during operation of the battery pack along the edges of the stack of battery cells, or “hot spots,” that are arranged adjacent to the first and second gap fillers. For example, the first edge of the stack may be formed by terminal caps of the battery cells, and the second edge of the stack may be formed by bottom edges of the battery cells, which may generate a greater amount of heat than the sides of the battery cells extending between the terminal caps and the bottom edges. In some embodiments, the bottom edges of the battery cells may be formed by bottom caps opposing the terminal caps. The presence of welds and terminals at the terminal caps and/or bottom edges (e.g., bottom caps) of the battery cells may cause relatively high resistance at these locations and, thus, relatively high heat generation.

In accordance with the present disclosure, the first and second gap fillers may include thermal conductivity constants that are greater than the thermal conductivity constant of the adhesive between the first and second gap fillers. For example, each of the first and second gap fillers may include a thermal conductivity constant between 2.8 and 3.7, 3.0 and 3.5, or 3.2 and 3.3. Thus, the first and second gap fillers act to efficiently dissipate the greater amount of heat adjacent the edges of the stack (e.g., adjacent the terminal caps and bottom edges or caps of the battery cells).

While the gap fillers may include relatively expensive materials (e.g., more expensive than a material of the adhesive), limiting the gap fillers to the edges of the stack of battery cells, as described above, may balance cost and heat transfer efficiency of the battery pack. Further, each of the first and second gap fillers may include a relatively low stress, modulus of elasticity, press in force, and elongation (e.g., compared to the adhesive), among other structural properties, such that the first and second gap fillers do not provide substantial structural support between the stack of battery cells and the enclosure of the battery pack. In contrast, the adhesive between the first and second gap fillers may provide structural support between the stack of battery cells and the enclosure of the battery pack via relatively strong structural properties of the adhesive. It is presently recognized that excluding the structural support at the edges of the battery cells, while providing the structural support along the side of the battery cells, may improve structural performance of the battery pack as a whole. In other words, employment of the first gap filler, the second gap filler, and the adhesive between the first and second gap fillers, as presently disclosed, may provide a dual benefit of improved heat transfer and improved structural performance of the battery pack relative to traditional embodiments.

In general, the above-described features, among other componentry of the battery pack, are employed to facilitate support of mechanical loads experienced by the battery pack, electrically isolate the battery cells from the enclosure of the battery pack, and effectively transfer heat away from the battery cells of the battery pack. These and other features are described in detail below with reference to the drawings.

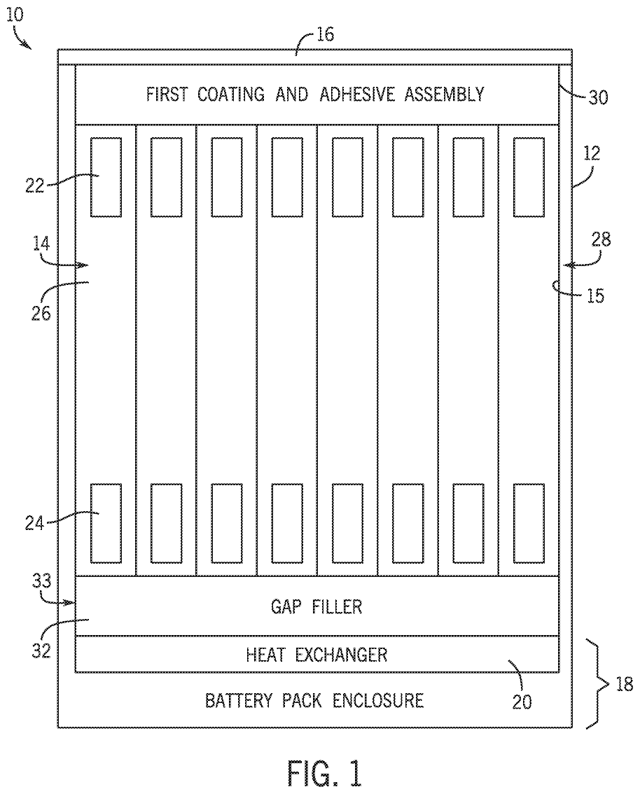

FIG. 1 is a schematic diagram of an embodiment of a battery pack 10 having an enclosure 12 and battery cells 14 disposed in an enclosure interior 15 defined by the enclosure 12. The battery cells 14, which may be referred to as electrochemical cells, may include lithium-ion (Li-ion) cells (e.g., lithium iron phosphate (LFP) cells), nickel-metal hydride (NiMH) cells, nickel-cadmium (NiCd) cells, lead-acid cells, or other types of rechargeable, secondary battery cells. In the illustrated embodiment, the enclosure 12 includes a first side 16 (e.g., a lid) and a second side 18 opposing the first side 16. A heat exchanger 20 may be disposed in, or attached to, the second side 18 of the enclosure 12. In some embodiments, the heat exchanger 20 may be configured to receive a heat exchange fluid configured to carry heat away from the second side 18 of the enclosure 12.

In the illustrated embodiment, each battery cell 14 includes a first terminal 22 (e.g., positive terminal) and a second terminal 24 (e.g., negative terminal) extending from or otherwise integrated with a terminal cap 26 of the battery cell 14. While not shown in the illustrated embodiment, bus bars may be employed to electrically couple the battery cells 14, via the terminals 22, 24, to form an electrically interconnected stack 28 of battery cells 14. For example, the battery cells 14 may be coupled in series, in parallel, or both (e.g., certain of the battery cells 14 may be connected in series and certain other of the battery cells 14 may be connected in parallel).

As shown, a first coating and adhesive assembly 30 may extend between the stack 28 of battery cells 14 and the first side 16 (e.g., lid) of the enclosure 12. The first coating and adhesive assembly 30 may include various features (e.g., cell coatings, enclosure coatings, a structural or thermal adhesive) configured to structurally couple cans of the battery cells 14 with the first side 16 of the enclosure 12, and electrically isolate the cans of the battery cells 14 from the first side 16 of the enclosure 12. Further, the first coating and adhesive assembly 30 may transfer heat from the battery cells 14 to the first side 16 (e.g., lid) of the battery pack 10.

In accordance with the present disclosure, a first gap filler 32 may extend between the stack 28 of battery cells 14 and the second side 18 (e.g., including the heat exchanger 20) of the enclosure 12. The first gap filler 32 may be a part of a second coating and adhesive assembly 33 disposed on an opposing side of the stack 28 of battery cells 14 from the first coating and adhesive assembly 30. The second coating and adhesive assembly 33 may include other componentry, such as componentry hidden from view in the illustrated perspective, including an adhesive (e.g., structural adhesive or thermal adhesive), a second gap filler, and other possibly componentry (e.g., cell coatings and enclosure coatings). For example, the adhesive may be disposed between the first gap filler 32 and the second gap filler. As described in detail with reference to later drawings, the first gap filler 32 and the second gap filler may include relatively high thermal conductivity constants (e.g., higher than that of the adhesive) and may be disposed in “hot spots” of the battery pack 10.

The first gap filler 32, for example, is disposed adjacent to the terminal caps 26 of the battery cells 14 in the illustrated embodiment. The terminal caps 26 may be welded to can bodies of the battery cells 14, and include the terminals 22, 24 extending therefrom or otherwise integrated therewith. Heat generation around the terminal caps 26 may be relatively high due to the relatively high resistance in these areas caused at least by the welds and the terminals 22, 24 described above. Inclusion of the first gap filler 32 adjacent the terminal caps 26 may improve heat transfer from the battery cells 14 to the enclosure 12 due to the relatively high thermal conductivity constant of the first gap filler 32. As an example, the thermal conductivity constant of the first gap filler 32 and the second gap filler (not shown) may be between approximately 2.8 and 3.7, 3.0 and 3.5, or 3.2 and 3.3. Other aspects of the first gap filler 32, the adhesive disposed behind the first gap filler 32 from the illustrated perspective, and the second gap filler disposed on an opposing side of the adhesive from the first gap filler 32 will be described in detail below with reference to later drawings.

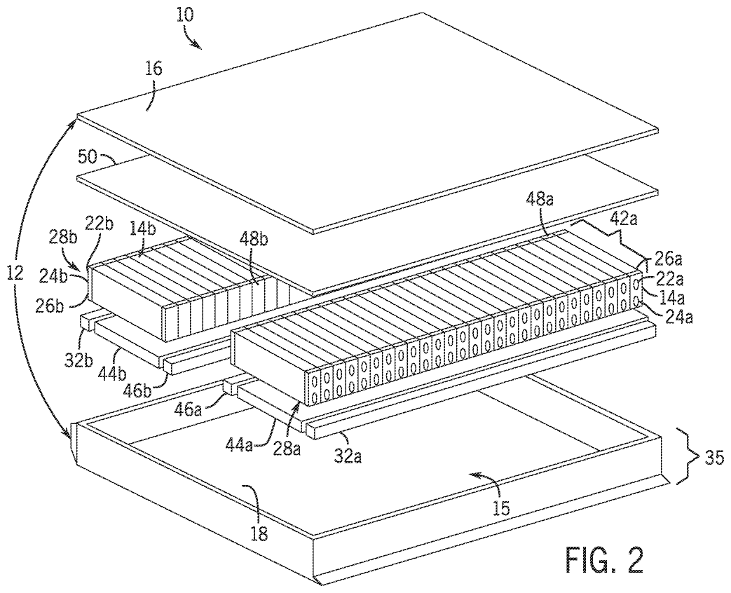

For example, FIG. 2 is an exploded perspective view of an embodiment of the battery pack 10 of FIG. 1. In the illustrated embodiment, the battery pack 10 includes the enclosure 12 and the battery cells 14 configured to be disposed in the enclosure interior 15 defined by an enclosure body 35 of the enclosure 12. As shown, the battery cells 14 may be arranged in a first stack 28a and a second stack 28b, although other arrangements are also possible. That is, any number of stacks 28 of battery cells 14 may be employed. The discussion below focuses on the first stack 28a, although it should be understood that the second stack 28b may include the certain similar features.

As shown, the first stack 28a includes a number of battery cells 14a arranged in a row with the terminal caps 26a of the battery cells 14a aligned along a first lateral side of the first stack 28a. The first gap filler 32a corresponding to the first stack 28a is disposed underneath a bottom side of the first stack 28a and aligned with the terminal caps 26a of the battery cells 14a. An adhesive 44a (e.g., structural or thermal adhesive) is disposed adjacent to the first gap filler 32a and underneath the bottom side of the first stack 28a of battery cells 14a, such that the adhesive 44a aligns with can bodies 42a of the battery cells 14a. A second gap filler 46a is disposed adjacent to the adhesive 44a and a second lateral side of the first stack 28a corresponding to bottom caps 48a (or edges) of the battery cells 14a of the first stack 28a, such that the adhesive 44a is between the first gap filler 32a and the second gap filler 46a.

The adhesive 44a may include thermal properties configured to enable the adhesive 44a to efficiently transfer heat to the second side 18 (e.g., bottom side) of the enclosure 12, structural properties configured to support mechanical loads experienced by the battery pack 10 at various intervals, or both. For example, the adhesive 44a may include a thermal conductivity constant between approximately 0.2 and 1.0, 0.4 and 0.9, or 0.6 and 0.8. Further, the adhesive 44a may include a shear strength of at least 6 Megapascals (MPa), a peel strength of at least 3 MPa, or both. Further still, the adhesive 44a may include a relatively high flexibility and elongation (e.g., greater than 90% elongation, greater than 100% elongation, greater than 140% elongation, or greater than 150% elongation).

The first and second gap fillers 32a, 46a corresponding to the first stack 28a of battery cells 14a may include higher thermal conductivity constants than the adhesive 44a. For example, each of the first and second gap fillers 32a, 46a corresponding to the first stack 28a of battery cells 14a may include a thermal conductivity constant between 2.8 and 3.7, 3.0 and 3.5, or 3.2 and 3.3. In general, materials with such relatively high thermal conductivity constants may not have as strong structural properties as materials (e.g., a material of the adhesive 44a) having lesser thermal conductivity constants. That is, each of the first and second gap fillers 32a, 46a may include a relatively low stress, modulus of elasticity, press in force, and elongation (e.g., compared to the adhesive 44a). However, it is presently recognized that excluding structural support at the edges of the battery cells 14a (e.g., at the terminal caps 26a and the bottom caps 48a), while providing the structural support along the side of the battery cells 14a (e.g., at the can bodies 42a of the battery cells 14a), may improve structural performance of the battery pack 10 as a whole. In other words, employment of the first and second gap fillers 32a, 46a and the adhesive 44 at presently disclosed locations of the first stack 28a of battery cells 14a may provide a dual benefit of improved heat transfer and improved structural performance of the battery pack 10.

As described above, the battery pack 10 in FIG. 2 includes the first stack 28a of battery cells 14a and the second stack 28b of battery cells 14b. The second stack 28b of battery cells 14b may include certain similar features as the first stack 28a of battery cells 14a. For example, the battery cells 14b of the second stack 28b may include terminal caps 26b, can bodies 42b, and bottom caps 48b. Further, the adhesive 44b corresponding to the second stack 28b may be disposed under (e.g., aligned with) the can bodies 42b of the battery cells 14b, the first gap filler 32b corresponding to the second stack 28b may be disposed under (e.g., aligned with) the terminal caps 26b of the battery cells 14b, and the second gap filler 46b may be disposed under (e.g., aligned with) the bottom caps 48 of the battery cells 14b.

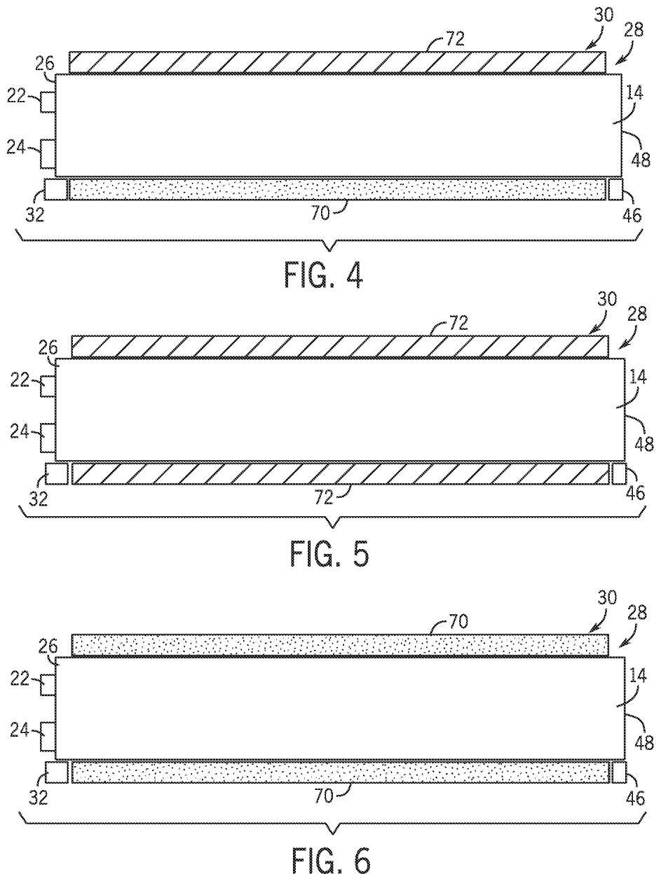

Further still, an additional adhesive 50 (e.g., structural or thermal adhesive) may be disposed between the first side 16 (e.g., the lid) of the enclosure 12 and the stacks 28a, 28b of battery cells 14a, 14b of the battery pack 10. In the illustrated embodiment, the additional adhesive 50 extends continuously over the stacks 28a, 28b of battery cells 14a, 14b, but it should be understood that, in another embodiment, a first portion of the additional adhesive 50 extends over the first stack 28a, a second portion of the additional adhesive 50 extends over the second stack 28b, and the first portion and second portion are separated. The additional adhesive 50 may include a thermal conductivity constant between approximately 0.2 and 1.0, 0.4 and 0.9, or 0.6 and 0.8. Further, the additional adhesive 50 may include a shear strength of at least 6 Megapascals (MPa), a peel strength of at least 3 MPa, or both. In some embodiments, the additional adhesive 50 includes the same or similar material composition, thermal properties, and/or structural properties as the adhesives 44a, 44b. In other embodiments, the additional adhesive 50 includes different material composition, thermal properties, and/or structural properties than the adhesives 44a, 44b. A detailed discussion of such material compositions, thermal properties, and structural properties is provided below with reference to FIGS. 4-6.

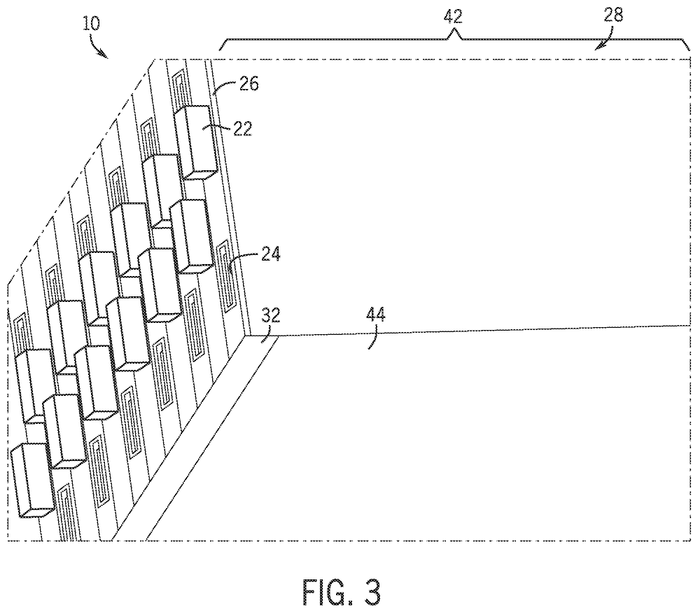

Before continuing with FIGS. 4-6, FIG. 3 is a perspective view of an embodiment of a portion of the battery pack 10 of FIG. 1, including the stack 28 of battery cells 14, the adhesive 44 illustrated in FIG. 2, and the first gap filler 32 positioned adjacent to the adhesive 44 and disposed under (e.g., aligned with) the terminal caps 26 of the battery cells 14. As previously described, the first gap filler 32 may include a relatively high thermal conductivity constant (e.g., higher than that of the adhesive 44), while the adhesive 44 may include relatively strong structural properties. In some embodiments, a material cost per area of the first gap filler 32 is greater than that of the adhesive 44. Thus, locating the first gap filler 32 adjacent to the terminal caps 26 of the battery cells 14 and the adhesive 44 adjacent to the can bodies 42 of the battery cells 14 may improve heat transfer performance away from the battery cells 14 while minimizing cost.

Further, the adhesive 44 may provide a greater amount of structural support between the stack 28 of battery cells 14 and the battery pack enclosure 12 illustrated in FIGS. 1 and 2. It is presently recognized that excluding the enhanced structural support at the edges of the battery cells 14, while providing the structural support along the can bodies 42 of the battery cells 14, may improve structural performance of the battery pack 10 as a whole. In other words, presently disclosed arrangements of the adhesive 44, the first gap filler 32, and the second gap filler 46 (e.g., in FIG. 2) may provide a dual benefit of improved heat transfer and improved structural performance of the battery pack 10 at a relatively low cost.

It should be noted that the adhesive 44 in FIGS. 1-3 and the additional adhesive 50 in FIG. 2 may include a structural adhesive (e.g., including relatively strong structural properties) or a thermal adhesive (e.g., including relatively strong thermal or heat transfer properties), depending on the embodiment. FIGS. 4-6 include various such embodiments. While reference numeral 44 is employed in FIGS. 1-3 to denote a generic adhesive on one side of the stack 28 of battery cells 14, and reference numeral 50 is employed in FIG. 2 to denote a generic adhesive on an opposing side of the stack 28 of battery cells 14, reference numeral 70 is employed to denote a thermal adhesive and reference numeral 72 is employed to denote a structural adhesive in the embodiments illustrated in FIGS. 4-6 and described in detail below.

For example, FIG. 4 is a schematic view of an embodiment of a portion of the battery pack 10 of FIG. 1, including one of the battery cells 14 of the stack 28, the gap filler 32, the additional gap filler 46, a thermal adhesive 70 between the gap filler 32 and the additional gap filler 46, and a structural adhesive 72 corresponding to the first coating and adhesive assembly 30. As shown, the gap filler 32, the additional gap filler 46, and the thermal adhesive 70 may extend within or into a common plane adjacent the battery cell 14. FIG. 5 is a schematic view of an embodiment of a portion of the battery pack 10 of FIG. 1, including one of the battery cells 14 of the stack 28, the gap filler 32, the additional gap filler 46, one structural adhesive 72 between the gap filler 32 and the additional gap filler 46, and another structural adhesive 72 corresponding to the first coating and adhesive assembly 30. As shown, the gap filler 32, the additional gap filler 46, and the structural adhesive 72 may extend within or into a common plane adjacent the battery cell 14. FIG. 6 is a schematic view of an embodiment of a portion of the battery pack 10 of FIG. 1, including one of the battery cells 14 of the stack 28, the gap filler 32, the additional gap filler 46, one thermal adhesive 70 between the gap filler 32 and the additional gap filler 46, and another thermal adhesive 70 corresponding to the first coating and adhesive assembly 30. As shown, the gap filler 32, the additional gap filler 46, and the thermal adhesive 70 may extend within or into a common plane adjacent the battery cell 14.

In general, each instance of the thermal adhesive 70 (e.g., in FIGS. 4 and 6) and the structural adhesive 72 (e.g., in FIGS. 4 and 5) may include a thermal conductivity constant between 0.2 and 1.0, 0.4 and 0.9, or 0.6 and 0.8. In some embodiments, the structural adhesive 72 may include a lower thermal conductivity constant than the thermal adhesive 70. As an example, the structural adhesive 72 may include a thermal conductivity constant between 0.2 and 0.5 and the thermal adhesive 70 may include a thermal conductivity constant between 0.5 and 1.0. Further, each instance of the thermal adhesive 70 and the structural adhesive 72 may include a shear strength of at least 6 Megapascals (MPa), a peel strength of at least 3 MPa, and/or an elongation percentage greater than 100%. In some embodiments, the structural adhesive 72 may include a higher elongation percentage than the thermal adhesive 70. As an example the structural adhesive 72 may include an elongation percentage of greater than 150% (e.g., 150% to 300%), whereas the thermal adhesive 70 may include an elongation percentage of greater than 100% (e.g., 100% to 150%).

The gap fillers 32, 46 may include relative high thermal conductivity constants (e.g., higher than that of the thermal adhesive 70 and the structural adhesive 72). For example, a thermal conductivity constant of each of the gap fillers 32, 46 may be between 2.8 and 3.7, 3.0 and 3.5, or 3.2 and 3.3. Further, the gap fillers 32, 46 may include relatively low press in force, stress, and modulus of elasticity (e.g., lower than that of the thermal adhesive 70 and the structural adhesive 72). Materials selected for the gap fillers 32, 46 and the adhesives 70, 72 may be selected to meet the above-described thermal and structural properties in accordance with the present disclosure.

The present disclosure is directed toward various embodiments of a battery pack that provide various technical benefits over traditional systems and methods, including improved support against mechanical loads, improved heat transfer away between battery cells of the battery pack and an enclosure of the battery pack, and improved electrical isolation of the battery cells from the enclosure, among other benefits.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery pack, comprising:
an enclosure forming an enclosure interior;
a stack formed by a plurality of battery cells disposed within the enclosure interior;
an adhesive extending between a wall of the enclosure and the stack;
a first gap filler extending between the wall and the stack, wherein the first gap filler is disposed adjacent to a first edge of the stack and includes a first thermal conductivity constant greater than a second thermal conductivity constant of the adhesive; and
a second gap filler extending between the wall and the stack, wherein the second gap filler is disposed adjacent to a second edge of the stack and includes a third thermal conductivity constant greater than the second thermal conductivity constant.

2. The battery pack of claim 1, comprising a heat exchanger formed in, or attached to, the wall of the enclosure.

3. The battery pack of claim 2, wherein the heat exchanger is configured to receive a heat exchange fluid.

4. The battery pack of claim 1, wherein each of the first thermal conductivity constant and the third thermal conductivity constant is at least 2.8.

5. The battery pack of claim 1, wherein the second thermal conductivity constant is at least 0.2.

6. The battery pack of claim 1, wherein the adhesive comprises a shear strength of at least 6 Megapascals (MPa), a peel strength of at least 3 MPa, or both.

7. The battery pack of claim 1, comprising an additional adhesive extending between an additional wall of the enclosure and the stack, wherein the additional wall opposes the wall such that the stack is between the wall and the additional wall.

8. The battery pack of claim 7, wherein the adhesive comprises a thermal adhesive, and the additional adhesive comprises a structural adhesive having a different material composition than the thermal adhesive.

9. The battery pack of claim 7, wherein the additional adhesive comprises a fourth thermal conductivity constant less than the second thermal conductivity constant.

10. The battery pack of claim 1, wherein each battery cell of the plurality of battery cells comprises a cell terminal cap adjacent to the first gap filler.

11. A battery pack, comprising:
an enclosure forming an enclosure interior;
a stack formed by a plurality of battery cells disposed within the enclosure interior;
a heat exchanger formed in, or attached to, a wall of the enclosure;
an adhesive extending between the wall and the stack; and
a gap filler extending between the wall and the stack, wherein the gap filler is disposed adjacent to an edge of the stack and includes a first thermal conductivity constant greater than a second thermal conductivity constant of the adhesive.

12. The battery pack of claim 11, wherein:
the first thermal conductivity constant is at least 2.8; and
the second thermal conductivity constant is at least 0.2.

13. The battery pack of claim 11, wherein the adhesive comprises a shear strength of at least 6 Megapascals (MPa), a peel strength of at least 3 MPa, or both.

14. The battery pack of claim 11, comprising an additional adhesive extending between an additional wall of the enclosure and the stack, wherein the additional wall opposes the wall such that the stack is between the wall and the additional wall.

15. The battery pack of claim 11, wherein each battery cell of the plurality of battery cells comprises a cell terminal cap adjacent to the gap filler.

16. A battery pack, comprising:
an enclosure forming an enclosure interior configured to receive a plurality of battery cells;
a heat exchanger formed in, or attached to, a wall of the enclosure;
a thermal adhesive extending within a plane adjacent to the wall; and
a gap filler extending within the plane adjacent to the wall, wherein the gap filler is disposed adjacent to an edge of the thermal adhesive and includes a first thermal conductivity constant greater than a second thermal conductivity constant of the thermal adhesive.

17. The battery pack of claim 16, comprising an additional gap filler extending within the plane adjacent to the wall, wherein the additional gap filler is disposed adjacent to an additional edge of the thermal adhesive, the additional edge opposes the edge, and the additional gap filler includes a third thermal conductivity constant greater than the second thermal conductivity constant.

18. The battery pack of claim 16, wherein:
the first thermal conductivity constant is at least 2.8; and
the second thermal conductivity constant is at least 0.2.

19. The battery pack of claim 16, comprising a structural adhesive extending within an additional plane adjacent to an additional wall of the enclosure, wherein the additional wall opposes the wall, and wherein the plane is substantially parallel with the additional plane.

20. The battery pack of claim 16, wherein each battery cell of the plurality of battery cells comprises a cell terminal cap adjacent to the gap filler.
